(19) United States
(12) Patent Application Publication
(10) Pub. No.: US 2012/0154250 A1
(43) Pub. Date: Jun. 21, 2012

(54) ANTENNA ARRAYS HAVING BAFFLE BOXES TO REDUCE MUTUAL COUPLING

(75) Inventors: Björn Lindmark, Sollentuna (SE); Anders Jensen, Johns Creek, GA (US)

(73) Assignee: LAIRD TECHNOLOGIES, INC., Earth City, MO (US)

(21) Appl. No.: 13/404,269

(22) Filed: Feb. 24, 2012

Related U.S. Application Data
(63) Continuation of application No. PCT/US2010/046701, filed on Aug. 25, 2010.
(60) Provisional application No. 61/275,049, filed on Aug. 25, 2009.

(51) Int. Cl. H01Q 21/00

(52) U.S. Cl. 343/893

(57) ABSTRACT

An exemplary antenna array includes at least two or more radiating elements coupled to a ground plane. The two or more radiating elements include a first radiating element separated from a second radiating element by at least one wall that extends away from the ground plane between the first and second radiating elements. The wall may be operable for reducing mutual coupling between the first and second radiating element.

### CROSS-REFERENCE TO RELATED APPLICATIONS

This application is a continuation of PCT International Application No. PCT/US2010/046701 filed Aug. 25, 2010 (Publication No. WO2011/031499), which claims priority to U.S. Provisional Application No. 61/275,049 filed Aug. 25, 2009. The entire disclosures of the above applications are incorporated herein by reference.

### FIELD

The present disclosure relates to antenna arrays having baffle boxes to reduce mutual coupling.

### BACKGROUND

This section provides background information related to the present disclosure which is not necessarily prior art.

Mutual coupling is a significant problem in antenna array design and in systems using antenna arrays. High levels of mutual coupling are equivalent to low isolation, which is an important parameter in radar and communication systems. In particular, it can be relatively difficult to maintain a high isolation between both co-polar antenna ports and cross-polar antenna ports in an antenna array.

### SUMMARY

This section provides a general summary of the disclosure, and is not a comprehensive disclosure of its full scope or all of its features.

An exemplary embodiment of an antenna array includes at least two or more radiating elements coupled to a ground plane. The two or more radiating elements include a first radiating element separated from a second radiating element by at least one wall that extends away from the ground plane between the first and second radiating elements. The wall may be operable for reducing mutual coupling between the first and second radiating element.

In another exemplary embodiment, a dual polarization antenna array includes a plurality of radiating elements forming a planar array extending in two orthogonal directions. Each radiating element is within a baffle box having side walls and a bottom coupled to a substantially planar ground plane. The sidewalls extend between corresponding pairs of adjacent radiating elements. The baffle boxes may be operable to reduce the mutual coupling between the radiating elements.

Another exemplary embodiment of a dual polarization antenna array includes a plurality of radiating elements forming a planar array extending in two orthogonal directions. Each radiating element is within a baffle box having side walls and a bottom coupled to a ground plane. The radiating elements are operable for receiving and/or transmitting two different polarizations. Each radiating element is fed by two probes such that each probe excites one of two orthogonal polarizations. The sidewalls extend between corresponding pairs of adjacent radiating elements. The baffle boxes may be operable to reduce the mutual coupling between the radiating elements.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view illustrating a baffle box with four side walls and a bottom part having a hole that allows other parts to enter or be positioned within the baffle box from below according to an exemplary embodiment;

FIG. 2 is a perspective view illustrating a radiating element in the form of a patch which has been placed inside the baffle box shown in FIG. 1, where the patch is fed by the two probes such that each probe excites one of two orthogonal polarizations, according to an exemplary embodiment;

FIG. 3 is a perspective view illustrating an exemplary embodiment in which first and second baffle boxes with first and second radiating elements (each in the form of a patch fed by two probes) have a shared or common baffle wall between the radiating elements, which helps reduce mutual coupling between the first and second radiating elements;

FIG. 4 is a perspective view of a piece of material having a pattern such that the material can be folded or otherwise formed into a baffle box, according to an exemplary embodiment;

FIG. 5 is a perspective view illustrating an exemplary baffle box that may be formed from the piece of material shown in FIG. 4;

FIG. 6 is an illustration of an exemplary computer simulation model that includes two-probe fed patches surrounded by baffle boxes according to exemplary embodiments;

FIG. 7 is a line graph illustrating S-parameter magnitudes in decibels for the example computer simulation model shown in FIG. 6 over a frequency bandwidth of about 1.90 gigahertz to 2.40 gigahertz;

FIG. 8 is an illustration of a computer simulation model that includes two-probe fed patches on an infinite ground plane without any baffle boxes;

FIG. 9 is a line graph illustrating S-parameter magnitudes in decibels for the example computer simulation model without baffle boxes shown in FIG. 8 over a frequency bandwidth of about 1.90 gigahertz to 2.40 gigahertz;

FIG. 10 is a perspective view illustrating an exemplary embodiment of a 16×4 antenna array with baffle boxes;

FIG. 11 is a perspective view illustrating an exemplary embodiment of 2×4 antenna array with baffle boxes; and

FIG. 12 is a perspective view illustrating an exemplary embodiment of a 4×4 antenna array with baffle boxes.

Corresponding reference numerals indicate corresponding parts throughout the several views of the drawings.

### DETAILED DESCRIPTION

Example embodiments will now be described more fully with reference to the accompanying drawings.

Exemplary embodiments of the present disclosure relate to antenna arrays or systems that include two or more radiating elements (e.g., patches, etc.), where shielding or baffle walls are between the radiating elements to reduce the mutual coupling and hence increase the port-to-port isolation. In various exemplary embodiments disclosed herein, the shielding or baffle walls are parts of boxes (also referred to herein as baffle boxes), where the boxes are placed on a relatively large ground plane common to all the radiating elements. The boxes may be generally rectangular, or they may have any other suitable non-rectangular shape (e.g., triangular or hexagonal when viewed from above, etc.) depending on the particular configuration of the antenna array. In addition, the walls of a baffle box may also be different on different sides. For example, the walls of a baffle box may vary in height and/or shape. In addition, horizontal, vertical, diagonal, etc. slots may be provided in the baffle walls to change the mutual coupling between different radiating elements. One or more walls may be configured such that it is slanted and not perpendicular to the ground plane.

As disclosed herein, the walls of the baffle boxes help to reduce the mutual coupling between radiating elements inside the boxes. In various embodiments, the walls of the boxes may be made sufficiently high so as to obscure the direct path from a first radiating element placed in a first baffle box to a second radiating element placed in a second baffle box. For example, in various embodiments the walls of the boxes may be at least as tall as the radiating element(s) disposed within the boxes formed by the walls (e.g., the walls have a height above a ground plane at least as high as a distance between the radiating element(s) and the ground plane, the walls extend higher over the ground plane than the radiating element(s), etc.).

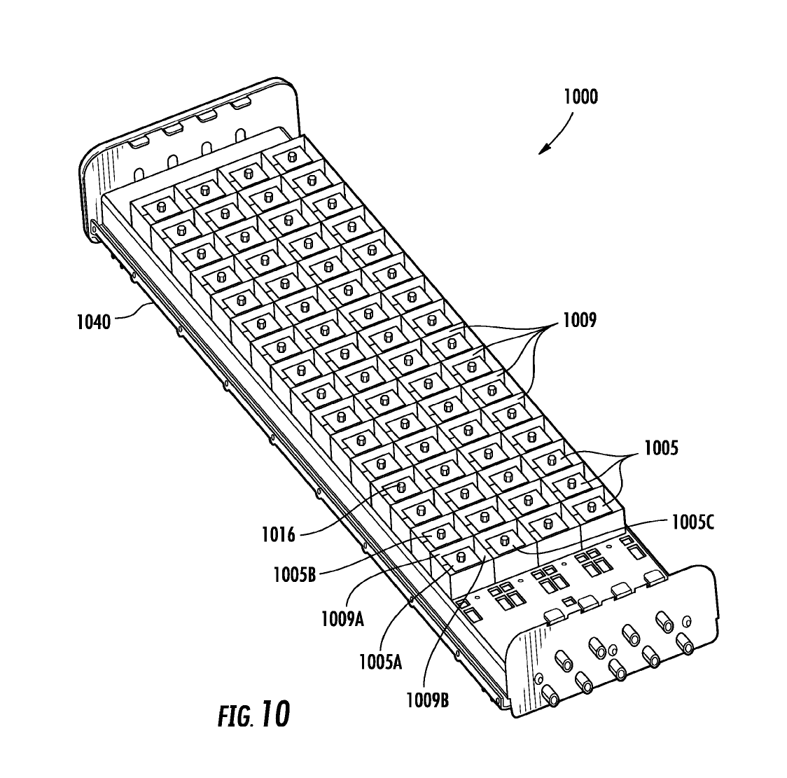

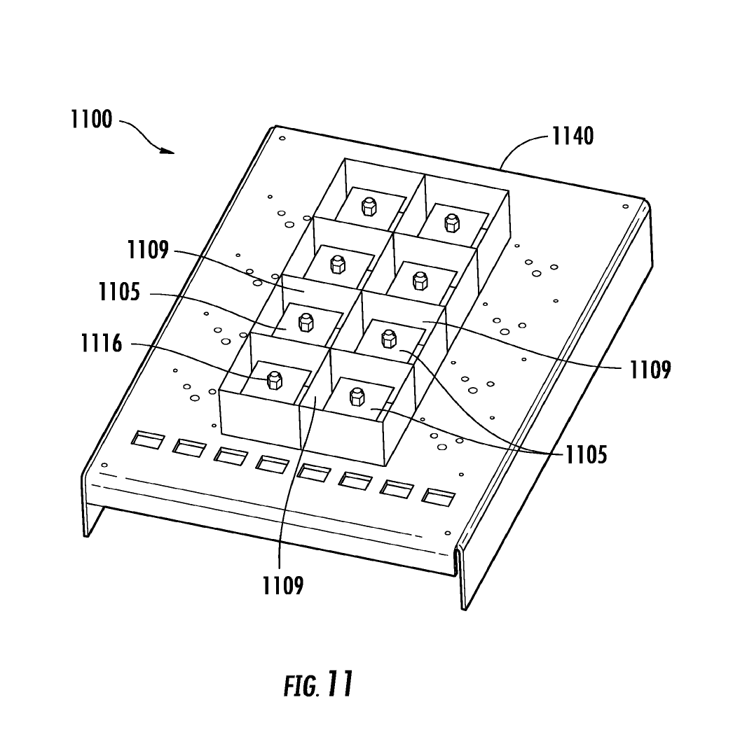

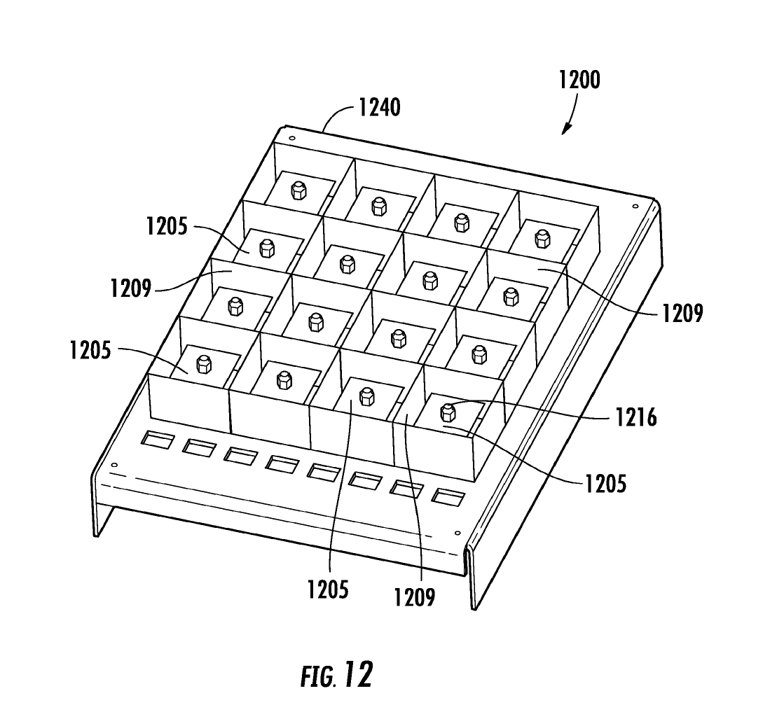

As disclosed herein, exemplary embodiments of antenna arrays/systems may include a large number of radiating elements (e.g., patches, etc.) arranged in a relative large array (e.g., the 16×4 array shown in FIG. 10, the 2×4 array shown in FIG. 11, the 4×4 array shown in FIG. 12, etc.). These exemplary embodiments may include walls between each pair of adjacent or side-by-side radiating elements, where those walls may be attached to a common ground plane. For example, the walls may be attached to the ground plane by electrically non-conductive adhesive tape, electrically-conductive adhesive tapes, other adhesives besides tapes, mechanical fasteners (e.g., screws, rivets, etc.), welding, soldering, among other suitable means for attaching the walls to the ground plane. In addition, other embodiments may include the walls being consolidated or integrally formed with the ground plane assembly such that the walls and ground plane assembly are a single component or have a monolithic construction, such as by using a suitable manufacturing process like casting, machining, metalized injection molding, etc.

In various embodiments, the walls between the radiating elements may be defined by or be an integral part of the baffle boxes in which the radiating elements are housed. In such embodiments, the baffle boxes may be attached to a common ground plane and/or to each other using electrically non-conductive adhesive tape, electrically-conductive adhesive tapes, other adhesives besides tapes, mechanical fasteners (e.g., screws, rivets, etc.), welding, soldering, among other suitable means for attaching the walls to the ground plane. In addition, other embodiments may include the baffle boxes being consolidated or integrally formed with the ground plane assembly such that the baffle boxes and ground plane assembly are a single component or have a monolithic construction, such as by using a suitable manufacturing process like casting, machining, metalized injection molding, etc. As recognized by the inventors hereof, the use of relatively thin electrically non-conductive adhesive tape causes the capacitance between the baffle box and the ground plane to become very large so that an effective ground path is created at microwave frequencies.

Aspects of the present disclosure may be especially helpful when the radiating elements operate in dual polarization. In such an antenna, some or all of the radiating elements are adapted to transmit and receive electromagnetic signals of two orthogonal polarizations. Such elements may be realized using patch radiators with two probes (e.g., coaxial probes, etc.) feeding two orthogonal states. Another way to create such a dual polarized radiator is to use two co-located orthogonal dipoles.

In various embodiments, an antenna array may be configured for use with a Chinese TD-SCDMA (Time Division Synchronous Code Division Multiple Access) system and/or Chinese TD-LTE (Time Division Long Term Evolution) systems in the frequency bandwidth of about 1880 megahertz to about 2400 megahertz. Alternative embodiments may be configured for use with other systems and/or for operation in other frequency bandwidths.

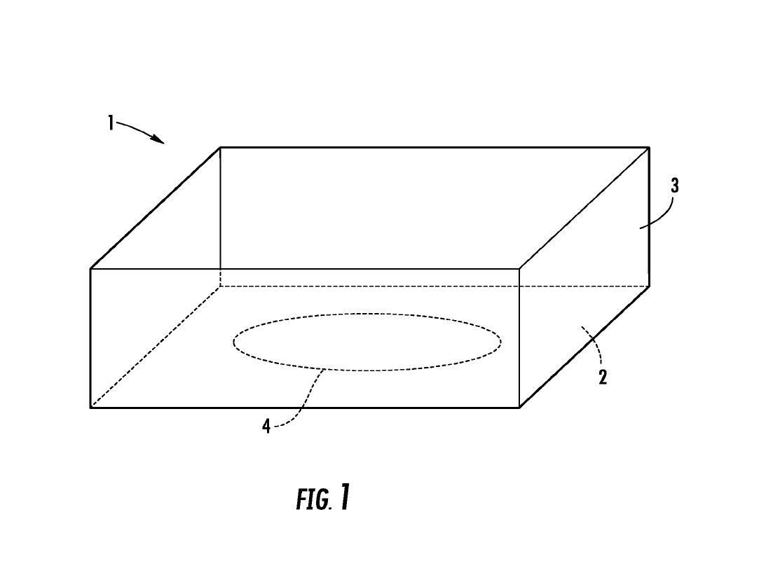

With reference now to the figures, FIG. 1 illustrates an exemplary embodiment that includes a baffle box 1 with four side walls 3 and a bottom part or wall 2. The bottom part has a hole 4 therethrough, which may be used for inserting or positioning various components (e.g., radiating element, probes, etc.) into the box 1 from below. In this particular embodiment, the baffle box 1 is generally rectangular, such that each wall thereof is generally rectangular and each sidewall has the same height. Alternative embodiments of the baffle box may include a non-rectangular shape (e.g., triangular or hexagonal when viewed from above, etc.), sidewalls that vary in height, and/or slots (e.g., horizontal slots, vertical slots, diagonal slots, combinations thereof, etc.) in one or more walls to change the mutual coupling between different radiating elements.

A wide range of electrically-conductive materials (e.g., metals, alloys, etc.) may be used for making the baffle box 1. In various embodiments, the baffle box 1 is made of sheet metal. In other embodiments, the baffle box 1 is made of an alloy or other suitable material.

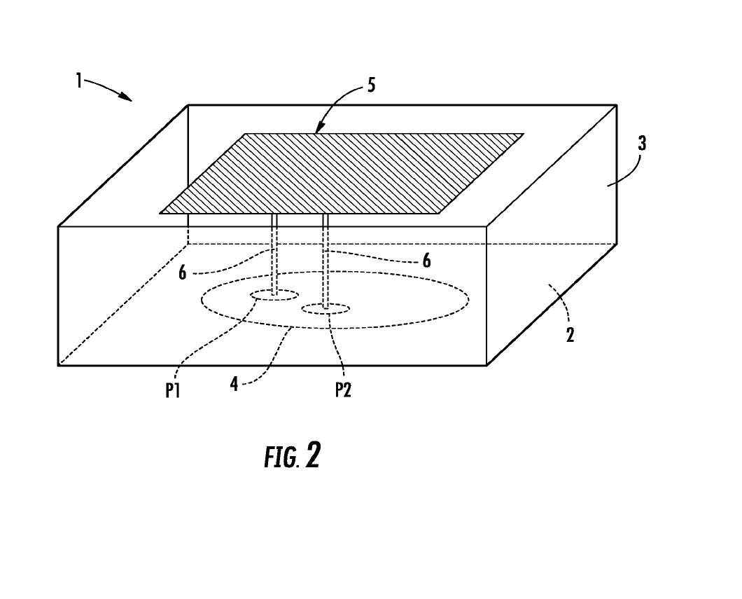

FIG. 2 illustrates an exemplary radiating element 5 that may be positioned within the baffle box 1 shown in FIG. 1. In this example, the radiating element 5 is in the form of a patch. Alternative embodiments may include other suitable radiating elements within the baffle box, besides a patch. In some embodiments, for example, stacked patch antennas may be used in which one or more patch elements are stacked on top of each other.

Also shown in FIG. 2, the patch 5 is fed by two probes (each indicated by reference number 6) via ports P1, P2 such that each probe 6 excites one of two orthogonal polarizations. Alternative embodiments may include other antenna feeding arrangements.

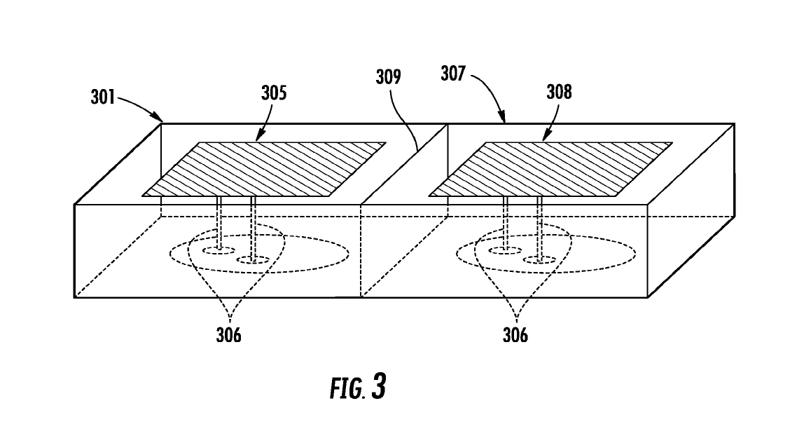

FIG. 3 illustrates an exemplary embodiment that includes first and second baffle boxes 301 and 307 in which are positioned first and second radiating elements 305 and 308, respectively. In this example, each radiating element 305 and 308 comprises a patch that is fed by two probes (each indicated by reference number 306) such that each probe 306 excites one of two orthogonal polarizations. Alternative embodiments may include other types of antennas and/or other types of feeding arrangements.

With further reference to the embodiment illustrated in FIG. 3, the first and second baffle boxes 301 and 307 are positioned relative to each other such that there is a common or shared baffle wall 309. The common baffle wall 309 is operable for helping reduce mutual coupling between the first and second radiating elements 305 and 308.

In some exemplary embodiments, the baffle boxes 301 and 307 may be formed such that the common baffle wall 309 is a single wall between the baffle boxes 301 and 307. For example, the baffle boxes 301 and 307 may be integrally or monolithically formed together with a single, common baffle wall 309 therebetween. Or, the baffle boxes 301 and 307 may be formed such that either or both of the baffle boxes 301 and 307 does not include the common baffle wall 309. In this latter example, the baffle wall 309 would then be attached to one or both baffle boxes 301 and 307 and/or to a ground plane, such as by electrically non-conductive adhesive tape, electrically-conductive adhesive tape, other adhesives besides tapes, mechanical fasteners (e.g., screws, rivets, etc.), welding, soldering, among other suitable means for attaching the wall to the ground plane. For other exemplary embodiments, the baffle boxes may be formed separately and/or independently, and then the baffle boxes may be placed relative to each other such that their respective sidewalls abut each other to form a baffle wall between the baffle boxes. In any event, a wide range of materials may be used for the baffle boxes, such as metals, alloys, and other suitable materials. In addition, each baffle box does not need to be configured identically to the other baffle box(es) of the antenna array. For example, a baffle box may have a different shape (e.g., non-rectangular, walls of varying heights, walls that are not perpendicular to the ground plane, etc.) and/or may be made out of a different material than another baffle box of the antenna array. In addition, other embodiments may include the baffle boxes being consolidated or integrally formed with the ground plane assembly such that the baffle boxes and ground plane assembly are a single component or have a monolithic construction, such as by using a suitable manufacturing process like casting, machining, metalized injection molding, etc.

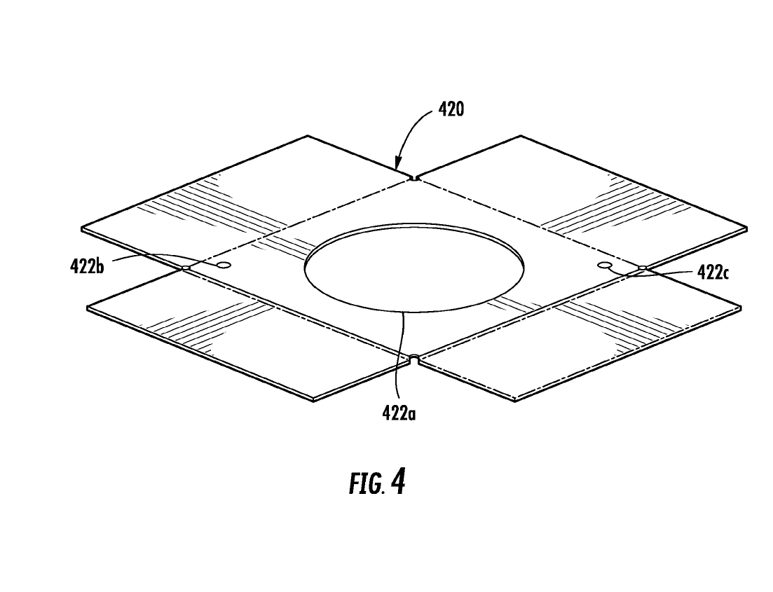

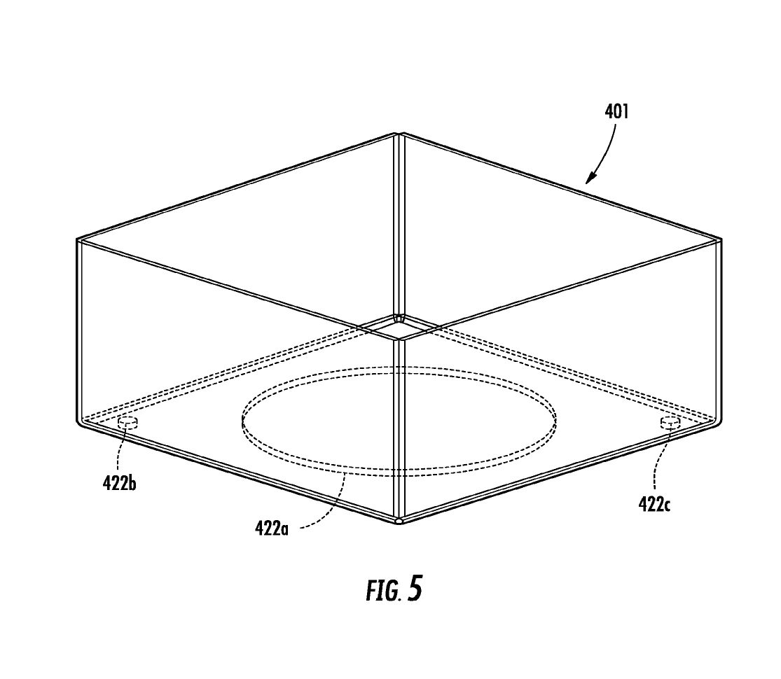

FIG. 4 illustrates a piece of material 420 (e.g., stainless steel, an alloy, a metal, etc.) that may be folded or otherwise formed into the baffle box 401 shown in FIG. 5. In this particular embodiment, three different circular openings 422a-c or holes are formed or cut into the flat piece of material 420 as shown in FIG. 4 before the material is folded into the box 401 shown in FIG. 5. Alternative embodiments may include forming the opening or holes after the material is folded into the box. Still other embodiments may include one or more non-circular openings or holes. Also, other suitable processes may also be employed in other embodiments to form a baffle box.

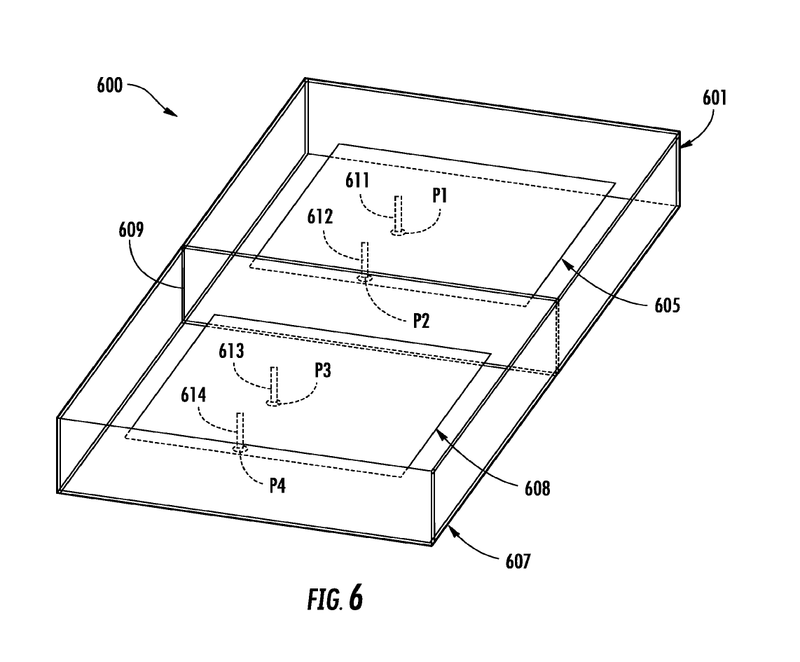

With reference now to FIGS. 6 through 9, a description will now be provided of exemplary, non-limiting computer simulation results obtained using Ansoft HFSS software. These computer simulation results and the models used to obtain the same are provided merely to help illustrate various aspects of the antenna arrays with baffle boxes. These computer simulation results and models are provided for purposes of illustration only and not for limitation, as other embodiments may include differently configured antenna arrays that what is shown in FIG. 6. For example, the computer simulation model of FIG. 6 includes only two patch elements, but the embodiments of FIGS. 10 and 11 include more than two patch elements. More specifically, the exemplary embodiment shown in FIG. 10 includes 64 patches or radiating elements arranged in a 16×4 array. The exemplary embodiment shown in FIG. 11 includes 8 patches or radiating elements arranged in a 2×4 array. The exemplary embodiment shown in FIG. 12 includes 16 patches or radiating elements arranged in a 4×4 array.

With reference back to FIG. 6, the computer simulation model 600 includes two radiating elements 605, 608. Each radiating element 605, 608 is in the form of a patch fed by two probes 611, 612 and 613, 614 each exciting one of two orthogonal polarizations. More specifically, the patch 605 is fed by probes 611 and 612 extending vertically from the patch 605 and providing two orthogonal slant 45 degree polarizations. The patch 608 is fed by probes 613 and 614 extending vertically from the patch 608 and providing two orthogonal slant 45 degree polarizations. Each patch 605, 608 has a length of about 55 millimeters and a width of about 55 millimeters. Each patch 605, 608 is placed about 10 millimeters above a ground plane (e.g., a ground plane generally coextensive with lower surfaces of each of baffle boxes 601, 607, etc.). The centers of the patches 605, 608 are separated or spaced apart by a distance of about 75 millimeters. Also in this model, the ports are numbered from top to bottom as P1, P2, P3, P4. The probe-fed patches 605, 608 are surrounded by respective baffle boxes 601, 607. Dimensionally, each baffle box 601, 607 has a height of about 20 millimeters, a length of about 75 millimeters, and a width of about 75 millimeters.

Continuing with the description of the computer simulation model shown in FIG. 6, the baffle boxes 601, 607 share a common baffle wall 609. As noted above for some exemplary embodiments, the baffle boxes 601, 607 may be formed such that there is a single wall between the baffle boxes 601, 607 that forms the common baffle wall 609. For example, the baffle boxes 601, 607 may be integrally or monolithically formed together with the single, common baffle wall 609 therebetween. In other exemplary embodiments, baffle boxes may be formed separately and the common baffle wall may be attached to one or both baffle boxes and/or to a ground plane, such as by electrically non-conductive adhesive tape, electrically-conductive adhesive tapes, other adhesives besides tapes, mechanical fasteners (e.g., screws, rivets, etc.), welding, soldering, among other suitable means for attaching the walls to the ground plane. For other exemplary embodiments, the baffle boxes may be formed separately with their own respective sidewalls, and then the baffle boxes may be placed relative to each other such that their sidewalls abut each other, thereby forming the common baffle wall between the baffle boxes. In addition, other embodiments may include the baffle boxes being consolidated or integrally formed with the ground plane assembly such that the walls and ground plane assembly are a single component or have a monolithic construction, such as by using a suitable manufacturing process like casting, machining, metalized injection molding, etc.

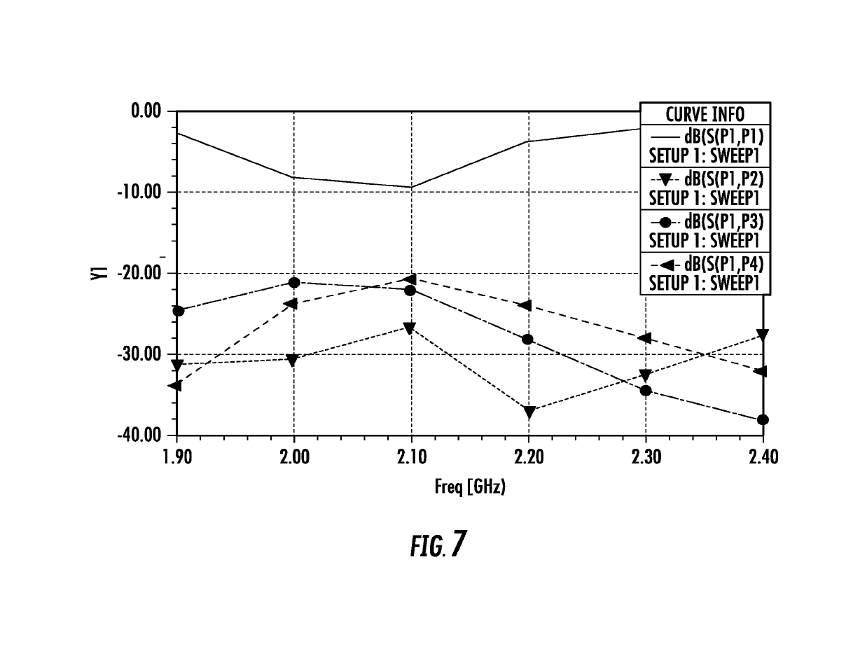

FIG. 7 is a line graph illustrating the magnitude of the S-parameters or scattering parameters in decibels for the example computer simulation model shown in FIG. 6 over a frequency bandwidth of about 1.90 gigahertz to 2.40 gigahertz. Specifically, FIG. 7 illustrates the magnitude of the reflection coefficient or power reflected from the antenna array (indicated as S(P1,P1)) and the scattering parameters S(P1,P2), S(P1,P3), and S(P1,P4). The S-parameter S(P1,P2) shows the intra-element cross-polar coupling. The S-parameters S(P1,P3) and S(P1,P4) show the inter-element co- and cross-polar coupling, respectively. Ideally, all these parameters should be zero—the value in decibels (dB) should approach minus infinity. As shown in FIG. 7, the S-parameters S(P1,P2), S(P1,P3), and S(P1,P4) are all below −20 dB across the frequency bandwidth of 1.90 gigahertz to 2.40 gigahertz.

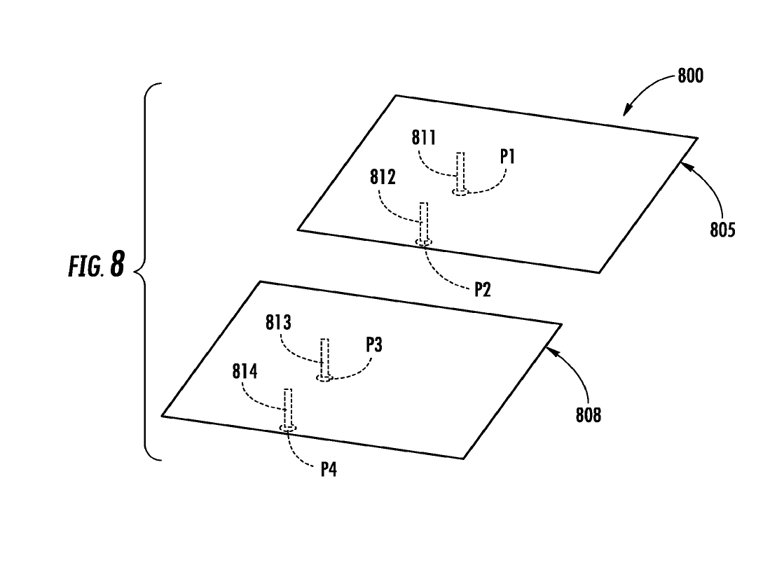

FIG. 8 is an illustration of another computer simulation model 800 that also includes two radiating elements 805, 808 in the form of probe-fed patches. But this computer simulation model does not include any baffle boxes, and the two probe-fed patches are modeled as being on an infinite ground plane.

Again, however, each patch 805, 808 is fed by two probes 811, 812 and 813, 814 that excite one of two orthogonal polarizations. More specifically, the patch 805 is fed by probes 811 and 812 extending vertically from the ground plane and patch 805, and that provide two orthogonal slant 45 degree polarizations. The patch 808 is fed by probes 813 and 814 extending vertically from the ground plane and patch 808, and that provide two orthogonal slant 45 degree polarizations. Each patch 805, 808 has a length of about 55 millimeters and a width of about 55 millimeters. Each patch 805, 808 is placed about 10 millimeters above the ground plane. The centers of the patches 805, 808 are separated or spaced apart by a distance of about 75 millimeters. Also in this model, the ports are numbered from top to bottom as P1, P2, P3, P4.

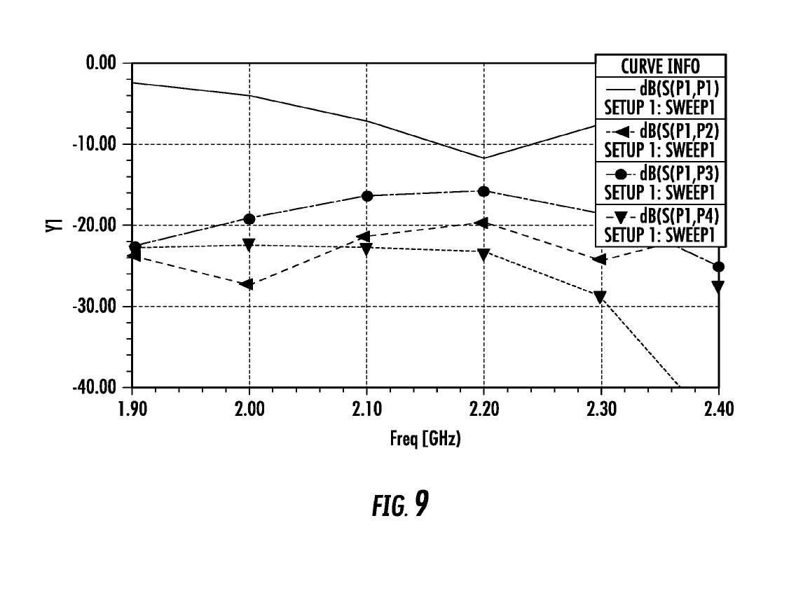

FIG. 9 is a line graph illustrating the magnitude of the S-parameters or scattering parameters in decibels for the example computer simulation model shown in FIG. 8 over a frequency bandwidth of about 1.90 gigahertz to 2.40 gigahertz. Specifically, FIG. 9 illustrates the magnitude of the reflection coefficient indicated as S(P1,P1), and scattering parameters S(P1,P2), S(P1,P3), and S(P1,P4). S(P1,P3) reaches −16 decibels. As indicate above, the S-parameter S(P1,P2) shows the intra-element cross-polar coupling. The S-parameters S(P1,P3) and S(P1,P4) show the inter-element co- and cross-polar coupling, respectively. Ideally, all these parameters should be zero—the value in decibels should approach minus infinity. As shown in FIG. 9, the S-parameter S(P1, P3) is at value of −16 decibels at 2.20 gigahertz.

As shown by the computer simulation results, the overall coupling is reduced by the baffles even though one component actually increases slightly. In practice, the radiating elements or patches of the antenna array would be tuned differently for an antenna array that has baffle boxes as compared to an antenna array that doesn't have baffle boxes, which thus make it relatively difficult to make direct comparisons between an antenna array with baffle boxes and an antenna array without baffle boxes.

FIG. 10 illustrates an exemplary embodiment of an antenna array 1000 that includes 64 radiating elements 1005 in the form of patches mounted on base structure 1040. In this example, the patches 1005 are arranged in an 16×4 array (an array with 16 rows and 4 columns, or vice versa depending on the orientation of the array). Also shown in FIG. 10, a baffle wall 1009 is disposed between each corresponding pair of immediately adjacent or side-by-side patches 1005. For example, a baffle wall 1009A is disposed between the patch 1005A in the lower left corner of the array and the patch 1005B immediately above in the same column but different row. A baffle wall 1009B is also disposed between the patch 1005A in the lower left corner of the array and the patch 1005C to the immediate right in the same row but different column. FIG. 10 further illustrates an exemplary nylon screw and nut 1016 at about the center of each patch 1005 that are used to position the patches 1005. The base structure 1040 may act as a ground plane for the antenna array 1000, and/or the antenna array 1000 and base structure 1040 may be positioned on another structure operable as a ground plane. Other embodiments may be configured differently than the array shown in FIG. 10, such as with other positioning means besides the nylon screws/nuts, with more or less than 64 patches, and/or with a different antenna array arrangement other than a 16×4 array. Also, other embodiments may include baffle walls disposed between less than all immediately adjacent pairs of patches or radiating elements.

FIG. 11 illustrates an exemplary embodiment of an antenna array 1100 that includes 8 radiating elements 1105 in the form of patches mounted on base structure 1140. In this example, the patches 1105 are arranged in an 2×4 array (an array with 2 rows and 4 columns, or vice versa depending on the orientation of the array). Also shown in FIG. 11, a baffle wall 1109 is disposed between each corresponding pair of immediately adjacent or side-by-side patches 1105. FIG. 11 further illustrates an exemplary nylon screw and nut 1105 at about the center of each patch 1116 that are used to position the patches 1105. In the illustrated embodiment, the antenna array 1100 has a length dimension of about 9 inches and a width dimension of about 4.5 inches. The base structure 1140 may act as a ground plane for the antenna array 1100, and/or the antenna array 1100 and base structure 1140 may be positioned on another structure operable as a ground plane. Other embodiments may be configured differently than the array shown in FIG. 11, such as with other positioning means besides the nylon screws/nuts, with larger or smaller dimensions than the example sizing shown in FIG. 11, with more or less than 8 patches, and/or with a different antenna array arrangement other than a 2×4 array. Further embodiments may also include baffle walls disposed between less than all immediately adjacent pairs of patches or radiating elements.

FIG. 12 illustrates an exemplary embodiment of an antenna array 1200 that includes 16 radiating elements 1205 in the form of patches mounted on base structure 1240. In this example, the patches 1205 are arranged in an 4×4 array (an array with 4 rows and 4 columns). Also shown in FIG. 12, a baffle wall 1209 is disposed between each corresponding pair of immediately adjacent or side-by-side patches 1205. FIG. 12 further illustrates an exemplary nylon screw and nut 1216 at about the center of each patch 1205 that are used to position the patches 1205. The base structure 1240 may act as a ground plane for the antenna array 1200, and/or the antenna array 1200 and base structure 1240 may be positioned on another structure operable as a ground plane. Other embodiments may be configured differently than the array shown in FIG. 12, such as with other positioning means besides the nylon screws/nuts, with more or less than 16 patches, and/or with a different antenna array arrangement other than a 4×4 array. Further embodiments may also include baffle walls disposed between less than all immediately adjacent pairs of patches or radiating elements.

The specific materials and dimensions provided herein are for purposes of illustration only as an antenna array may be configured from different materials and/or with different dimensions depending, for example, on the particular end use and/or frequencies intended for the antenna array.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. Similarly, the terms “can” and “may” and their variants are intended to be non-limiting, such that recitation that an embodiment can or may comprise certain elements or features does not exclude other embodiments of the present technology that do not contain those elements or features. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. Terms such as “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The headings (such as “Background” and “Summary”) and sub-headings used herein are intended only for general organization of topics within the present technology, and are not intended to limit the disclosure of the present technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof.

Any citation of references herein does not constitute an admission that those references are prior art or have any relevance to the patentability of the technology disclosed herein. Any discussion of the content of references cited in the Background is intended merely to provide a general summary of assertions made by the authors of the references, and does not constitute an admission as to the accuracy of the content of such references.

As used herein, the words “preferred” and “preferably” refer to embodiments of the technology that afford certain benefits, under certain circumstances. But other embodiments may also be preferred, under the same or other circumstances. Furthermore, the recitation of one or more preferred embodiments does not imply that other embodiments are not useful, and is not intended to exclude other embodiments from the scope of the technology.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An antenna array comprising at least two or more radiating elements coupled to a ground plane, the two or more radiating elements including a first radiating element separated from a second radiating element by at least one wall that extends away from the ground plane between the first and second radiating elements such that the wall reduces mutual coupling between the first and second radiating elements.

2. The antenna array of claim 1, wherein the at least one wall between the first and second radiating elements extends higher over the ground plane than the first and second radiating elements.

3. The antenna array of claim 1, wherein at least one of the first and second radiating elements is within a baffle box that includes the at least one wall between the first and second radiating elements.

4. The antenna array of claim 3, wherein:
each radiating element is within a baffle box; and/or
the baffle box includes four sidewalls and a bottom part.

5. The antenna array of claim 1, wherein:
the first radiating element is within a first baffle box;
the second radiating element is within a second baffle box; and
at least one of the first and second baffle boxes includes the at least one wall between the first and second radiating elements.

6. The antenna array of claim 5, wherein the at least one wall between the first and second radiating elements is defined by sidewalls of the first and second baffle boxes that are positioned relative to each other such that the sidewalls are in abutting contact with each other, the abutting sidewalls operable to reduce the mutual coupling between the first and second radiating elements.

7. The antenna array of claim 1, wherein:
at least one of the radiating elements comprises a patch; and/or
at least one radiating element is operable for receiving and/or transmitting two different polarizations, each of said two polarizations being excited or received from one of two ports.

8. The antenna array of claim 1, wherein the array includes four or more radiating elements forming a planar array extending in two orthogonal directions.

9. The antenna array of claim 1, wherein at least one of the radiating elements is fed by two probes such that each probe excites one of two orthogonal polarizations.

10. The antenna array of claim 1, wherein:
the antenna array includes more than two radiating elements, and
at least one wall is between each corresponding pair of adjacent radiating elements that extends away from the ground plane and that is operable for reducing mutual coupling between the corresponding pair of adjacent radiating elements.

11. The antenna array of claim 10, wherein the walls between the corresponding pairs of adjacent radiating elements are attached to the ground plane by adhesive tape.

12. The antenna array of claim 1, wherein:
at least one radiating element is within a baffle box attached to the ground plane by adhesive tape; and/or
the radiating elements comprise at least one patch stacked on top of another patch; and/or
at least one radiating element is fed by one or more coaxial probes.

13. The antenna array of claim 1, wherein:
the ground plane is substantially planar and horizontally oriented; and
the at least one wall is substantially vertical relative to the ground plane.

14. The antenna array of claim 1, wherein:
the antenna array is operable within a frequency band of about 1880 megahertz to about 2400 megahertz; and/or
the antenna array is operable with a TD-SCDMA (Time Division Synchronous Code Division Multiple Access) system and/or TD-LTE (Time Division Long Term Evolution) system.

15. A dual polarization antenna array comprising a plurality of radiating elements forming a planar array extending in two orthogonal directions, each said radiating element is within a baffle box having side walls and a bottom coupled to a ground plane, the radiating elements being operable for receiving and/or transmitting two different polarizations, each said radiating element being fed by two probes such that each probe excites one of two orthogonal polarizations, the sidewalls extending between corresponding pairs of adjacent radiating elements, whereby the baffle boxes are operable to reduce the mutual coupling between the radiating elements.

16. The antenna array of claim 15, wherein:
the sidewalls of the baffle boxes extends higher over the ground plane than the radiating elements and/or
the baffle boxes are attached to the ground plane by adhesive tape; and/or
the radiating elements comprise at least one patch stacked on top of another patch.

17. The antenna array of claim 16, wherein:
the ground plane is substantially planar and horizontally oriented; and
the sidewalls of the baffle boxes are substantially vertical relative to the ground plane.

18. A dual polarization antenna array comprising a plurality of radiating elements forming a planar array extending in two orthogonal directions, each said radiating element is within a baffle box having side walls and a bottom coupled to a substantially planar ground plane, the sidewalls extending between corresponding pairs of adjacent radiating elements, whereby the baffle boxes are operable to reduce the mutual coupling between the radiating elements.

19. The antenna array of claim 18, wherein:
the baffle boxes are attached to the ground plane by adhesive tape; and
each radiating element is fed by one or more coaxial probes.

20. The antenna array of claim 18, wherein:
the ground plane is horizontally oriented; and
the sidewalls of the baffle boxes are substantially vertical relative to the ground plane.
